(19) United States
(12) Patent Application Publication
(10) Pub. No.: US 2020/0173534 A1
(43) Pub. Date: Jun. 4, 2020

(54) TORQUE-SENSING VARIABLE SPEED BELT DRIVE WITH HELICAL STRUT

(71) Applicant: AGCO Corporation, Duluth, GA (US)

(72) Inventor: David Wayne O'Reilly, Hesston, KS (US)

(21) Appl. No.: 16/637,819

(22) PCT Filed: Jul. 9, 2018
(86) PCT No.: PCT/IB2018/055044

§ 371 Date: Feb. 10, 2020

Related U.S. Application Data
(60) Provisional application No. 62/543,843, filed on Aug. 10, 2017.

(51) Int. Cl. F16H 55/56; F16H 61/662

(52) U.S. Cl. CPC F16H 55/56; F16H 9/18; F16H 61/66272

(57) ABSTRACT

A variable speed belt drive system having a driving pulley, a V-belt, and a driven pulley connected to the driving pulley with the V-belt. The driven pulley includes a pulley shaft rotatable about a pulley axis, an inboard pulley-half having a first contact surface that is inclined relative to the axis of the pulley shaft that defines a first belt-contacting wall of driven pulley, wherein the first contact surface is fixed relative to the pulley shaft. The driven pulley has an outboard pulley-half having a second contact surface that is opposite the first contact surface and that is inclined relative to the axis of the pulley shaft, the outboard pulley-half being movable relative the inboard pulley-half such that the second contact surface is moveable relative to the driven pulley shaft. The inboard pulley-half is connected to the outboard pulley-half with two or more tension struts.

### BACKGROUND OF THE INVENTION

### Field of Invention

This invention relates to variable speed drive systems and more particularly to torque sensing pulleys for such drive systems.

### Description of Related Art

Variable speed drive systems utilizing a V-belt and pulley drive system for transferring power from a driving pulley to a driven pulley are well known. In such systems a driving pulley, connected with the output shaft of an engine or other source of power, and a driven pulley connected with driven shaft, are made to include a fixed pulley-half and a movable pulley-half, with the spacing between the respective pulley-halves determining the drive ratio from the input shaft to the output shaft. Such variable speed drive systems are used as a part of the drive system of such devices as agricultural machines, snowmobiles, automobiles, golf carts, utility vehicles, and the like.

In one example of a torque-sensing variable speed drive, the driven pulley relies on the combination of a pretension spring and a torque feedback ramp to exert the required pressure on the movable pulley pulley to maintain the optimum side load on the belt. The floating pulley-half is pushed towards the fixed pulley-half using a fixed-angle set of cams and a spring. This pushing action and associated mechanism utilizes the driven shaft for support and torsional constraint. With prior torque-sensing pulleys, this pushing action changes proportionally with torque to provide sufficient belt squeeze and belt tension at peak torque but less squeeze and tension at lower torque. This reduction at lower torque improves belt life. The previously mentioned spring is needed to maintain a prevailing squeeze between the pulley-halves and the belt so that friction is always present, as some friction is required for the torque-sensing reaction to develop. However, this pre-load provided by the spring is only in the axial direction and does not prevent separation (backlash) of the otherwise mating cams in rotational direction during deceleration and back-driving. Cam separation can result in rapid closure or slamming and damage to cams when forward-driving is resumed.

### OVERVIEW OF THE INVENTION

In one embodiment, the invention is directed to a variable speed belt drive system having a driving pulley, a V-belt, and a driven pulley connected to the driving pulley with the V-belt. The driven pulley includes a pulley shaft rotatable about a pulley axis, an inboard pulley-half having a first contact surface that is inclined relative to the axis of the pulley shaft that defines a first belt-contacting wall of driven pulley, wherein the first contact surface is fixed relative to the pulley shaft. The driven pulley has an outboard pulley-half having a second contact surface that is opposite the first contact surface and that is inclined relative to the axis of the pulley shaft, the outboard pulley-half being movable relative the inboard pulley-half such that the second contact surface is moveable relative to the driven pulley shaft. The inboard pulley-half is connected to the outboard pulley-half with two or more tension struts. Each strut extends through a slot in the outboard pulley-half so that the length of each strut is greater than spacing between the pulley-halves. A first end of each of the struts is connected to a hub of the inboard pulley-half and a second end of each of the struts is connected to a hub of the outboard pulley-half so that the outboard pulley-half can rotate relative to inboard pulley-half.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a perspective view of a variable speed drive system;

FIG. 2 is a perspective view of a pulley of the drive system of FIG. 1 in accordance with principles of the present invention;

FIG. 3 is another perspective view of a pulley of FIG. 2;

FIG. 4 is an elevational view of the pulley FIG. 2;

FIG. 5 is a sectional view of the pulley of FIG. 2;

FIG. 6A is an elevational view of the struts used with the pulley of FIG. 2; and

FIG. 6B is an end view of the struts used with the pulley of FIG. 2.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

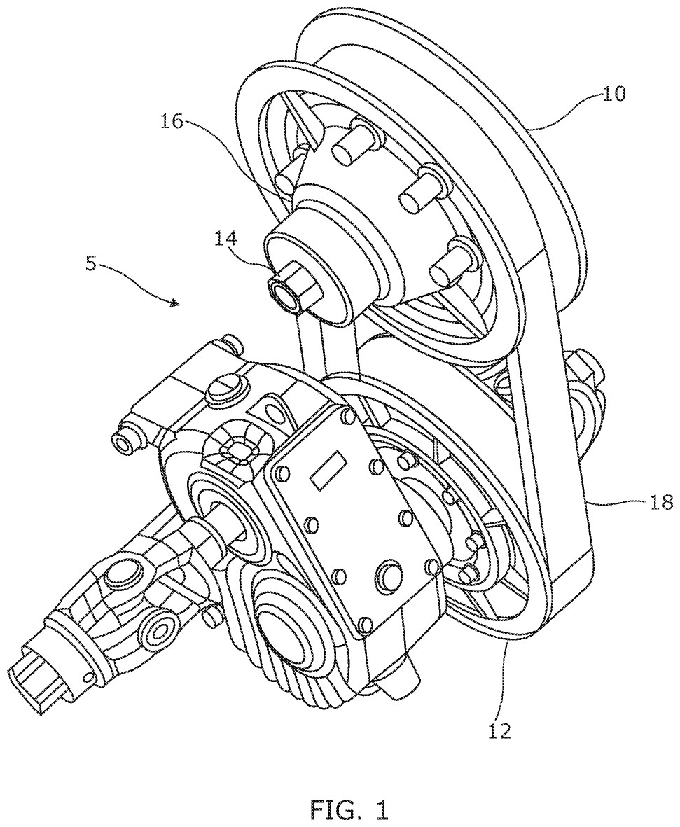

Referring now to the drawings, and particularly to FIG. 1 thereof, there is shown a variable speed belt drive system 5 having a driving pulley 10 and a driven pulley 12. The driving pulley 10 is adapted to be connected to a source of power (not shown) that provides power through an input power shaft 14 that extends into and is drivingly received in a hub 16 of the driving pulley 10. The driving pulley 10 forms a V-shaped annular slot to receive a V-belt 18. Driving pulley 10 desirably has a movable pulley surface that is movable in an axial direction toward and away from a fixed pulley surface as is known in the art so the effective radius of the driving pulley 10 may be changed to provide a variable input to the V-belt 18. The V-belt 18 also wraps around the driven pulley 12 which has a driven pulley shaft 20 connected to an output or driven shaft (not shown). The driving pulley 10 is the master or control unit that is used to adjust the speed ratio between the driving pulley 10 and driven pulley 12. The driven pulley 12 is the slave and self-adjusts using the torque-sensing apparatus to develop adequate squeeze between pulleys 10, 12 and the V-belt 18 as described below.

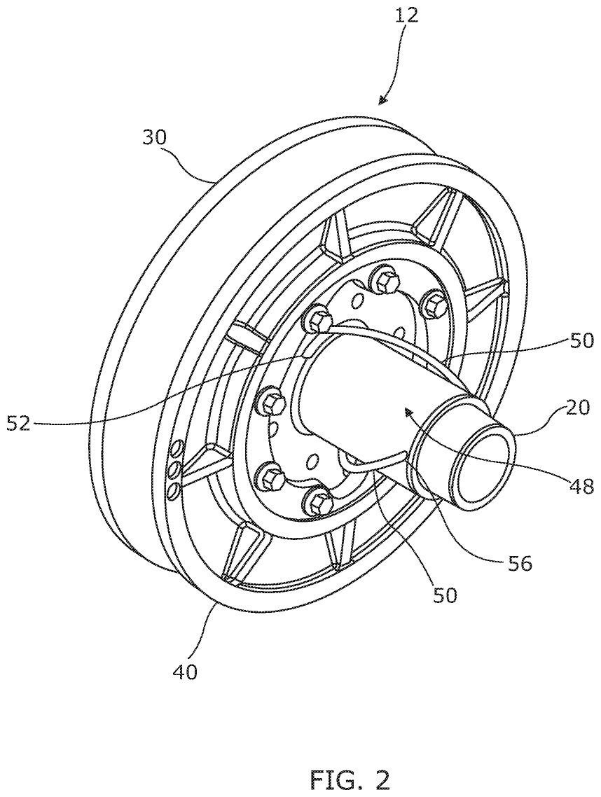

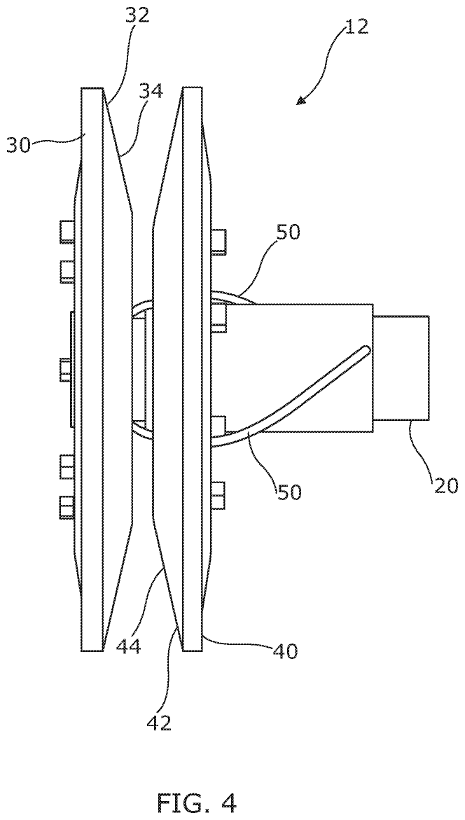

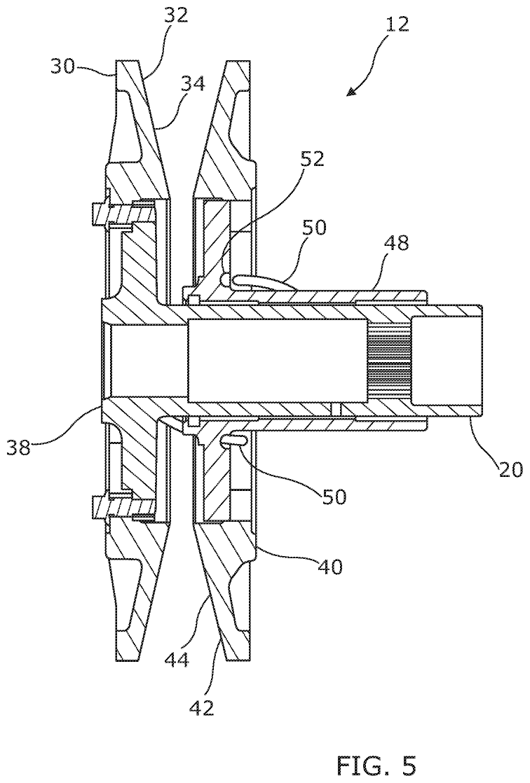

Turning now to FIGS. 2-5 the driven pulley 12 has an inboard pulley-half 30 with a fixed pulley wall 32 that includes a contact surface 34 that is inclined relative to the axis of the driven pulley shaft 20 and that defines one belt-contacting wall of driven pulley 12. Surface 34 is fixed relative to the axis of the driven pulley shaft 20 and is therefore hereinafter referred to as the fixed pulley face. The driven pulley 12 has an outboard pulley-half 40 with a pulley wall 42 on the side opposite from fixed pulley face 34 that includes a second contact surface 44 that is also inclined relative to the axis of the driven pulley shaft 20. The outboard pulley-half 40 is movable relative the inboard pulley-half 30 such that the second contact surface 44 is moveable relative to the axis of the driven pulley shaft 20 and is therefore hereinafter referred to as the moveable pulley face.

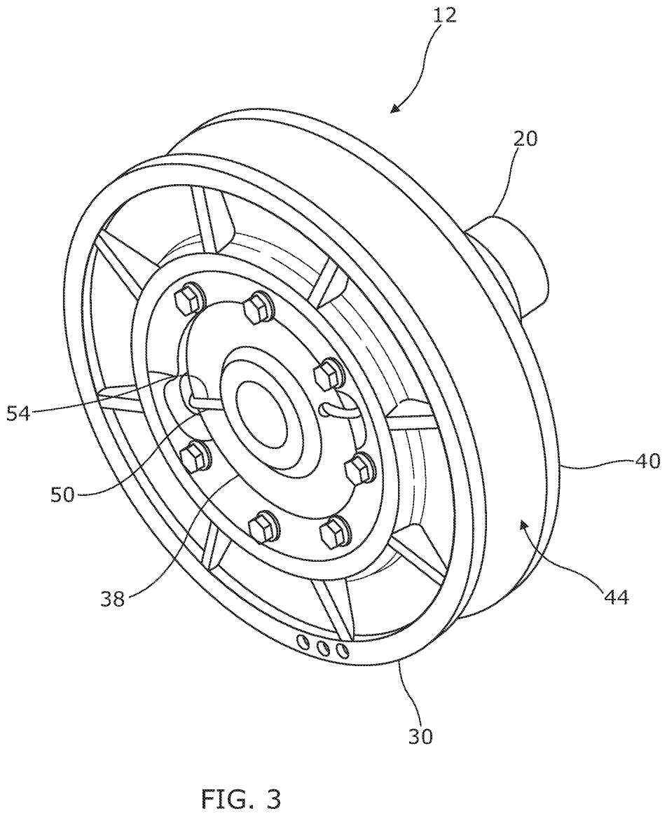

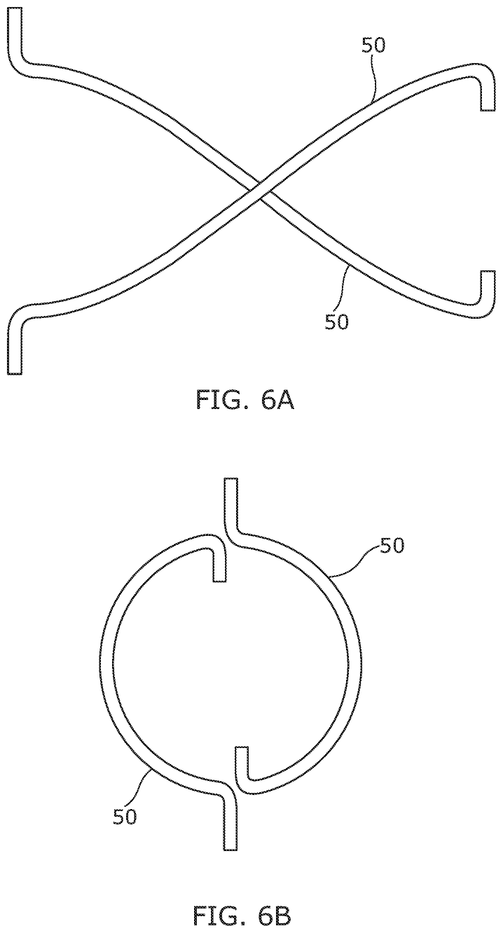

According to the invention, the inboard pulley-half 30 is connected to the outboard pulley-half 40 with two or more tension struts 50. The struts 50 extend beyond the outboard pulley-half 40 through a slot 52 in the outboard pulley-half 40 so that the length of each strut 50 is greater than spacing between the pulley-halves 30, 40. A first end 54 of each of the struts 50 is connected to the hub 38 of the inboard pulley-half 30 as best seen in FIG. 3. A second end 56 of each of the struts 50 is connected to the hub 48 of the outboard pulley-half 40. Thus, both ends 54, 56 of struts 50 are anchored but free to pivot in the tangential or circumferential direction about the axis of rotation so that the outboard pulley-half 40 can rotate relative to inboard pulley-half 30. With zero windup between the pulley-halves 30, 40, the struts 50 would be parallel to each other and parallel with the axis of rotation of the driven pulley shaft 20. With any windup or relative rotation between the pulley-halves 30, 40, the struts 50 wrap about the axis and assume a helical shape as shown in FIGS. 2, 6A and 6B. Rotation of the outboard pulley-half 40 relative to the inboard pulley-half 30 results in a helical winding up of the struts 50 such that the spacing between inboard and outboard pulley halves 30, 40 changes.

Desirably, the struts 50 are solid spring-grade wire with the ends 54, 56 anchored such that any windup between pulley-halves 30, 40 applies a torsional action to the cross-section of the struts 50. In affect these tension struts 50 then also become torsional members and can function as springs to provide a prevailing closing (squeeze) force between pulley-halves 30, 40.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A variable speed belt drive system comprising:
a driving pulley,
a V-belt,
a driven pulley connected to the driving pulley with the V-belt, the driven pulley comprising a pulley shaft rotatable about a pulley axis, an inboard pulley-half having a first contact surface that is inclined relative to the axis of the pulley shaft that defines a first belt-contacting wall of driven pulley, wherein the first contact surface is fixed relative to the pulley shaft, and an outboard pulley-half having a second contact surface that is opposite the first contact surface and that is inclined relative to the axis of the pulley shaft, the outboard pulley-half being movable relative the inboard pulley-half such that the second contact surface is moveable relative to the driven pulley shaft, wherein the inboard pulley-half is connected to the outboard pulley-half with two or more tension struts.

2. The variable speed belt drive system of claim 1 wherein each of the struts extends through a slot in the outboard pulley-half so that the length of each strut is greater than spacing between the pulley-halves.

3. The variable speed belt drive system of claim 2 wherein a first end of each of the struts is connected to a hub of the inboard pulley-half and a second end of each of the struts is connected to a hub of the outboard pulley-half so that the outboard pulley-half can rotate relative to inboard pulley-half.

4. The variable speed belt drive system of claim 3 wherein the struts have a first condition and wherein the struts have a second condition in which the outboard pulley-half is rotated relative the inboard pulley-half, wherein in the second condition the struts wrap about the axis resulting in a helical winding up of the struts such that the spacing between inboard pulley-half and the outboard pulley-half changes.

5. The variable speed belt drive system of claim 4 wherein the first ends and second ends of the struts are anchored such that any windup between the inboard and outboard pulley-halves applies a torsional action to the cross-section of the struts such that the struts provide a prevailing closing force between the inboard and outboard pulley-halves.
